(19) United States
(12) Patent Application Publication
(10) Pub. No.: US 2025/0377781 A1
(43) Pub. Date: Dec. 11, 2025

(54) TECHNIQUES FOR DISPLAYING CONTROLS

(71) Applicant: Apple Inc., Cupertino, CA (US)

(72) Inventors: Mischa K. MCLACHLAN, San Francisco, CA (US); Calvin R. GAISFORD, Santa Clara, CA (US); Jared K. MCGANN, San Jose, CA (US)

(21) Appl. No.: 19/230,656

(22) Filed: Jun. 6, 2025

Related U.S. Application Data
(60) Provisional application No. 63/657,899, filed on Jun. 9, 2024.

(51) Int. Cl. G06F 3/0488; G06F 1/16; G06F 3/04817

(52) U.S. Cl. CPC G06F 3/0488; G06F 1/163; G06F 3/04817

(57) ABSTRACT

The present disclosure generally relates to displaying controls. Some techniques are for displaying controls in accordance with some embodiments.

### CROSS-REFERENCE TO RELATED APPLICATIONS

The present application claims priority to U.S. Provisional Patent Application Ser. No. 63/657,899, entitled “TECHNIQUES FOR DISPLAYING CONTROLS” filed Jun. 9, 2024, which is hereby incorporated by reference in its entirety for all purposes.

### FIELD

The present disclosure relates generally to computer user interfaces, and more specifically to techniques for displaying controls.

### BACKGROUND

Electronic devices often display controls that correspond to external accessories. Such controls correspond to various operations of the external accessories.

### SUMMARY

Some techniques for displaying controls using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for displaying controls. Such processes and interfaces optionally complement or replace other processes for displaying controls. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is communication with one or more input devices and one or more display generation components is described. In some embodiments, the method comprises: while displaying, via the one or more display generation components, a user interface element to perform a set of one or more actions, detecting, via the one or more input devices, an input corresponding to the user interface element; and in response to detecting the input corresponding to the user interface element to perform the set of one or more actions: in accordance with a determination that a first set of one or more criteria is satisfied, displaying, via the one or more display generation components, a prompt to confirm performance of the set of one or more actions; and in accordance with a determination that the first set of one or more criteria is not satisfied, displaying, via the one or more display generation components, an indication corresponding to performance of the set of one or more actions without displaying the prompt.

In some embodiments, a non-transitory computer-readable storage medium storing one or more programs configured to be executed by one or more processors of a computer system that is communication with one or more input devices and one or more display generation components is described. In some embodiments, the one or more programs includes instructions for: while displaying, via the one or more display generation components, a user interface element to perform a set of one or more actions, detecting, via the one or more input devices, an input corresponding to the user interface element; and in response to detecting the input corresponding to the user interface element to perform the set of one or more actions: in accordance with a determination that a first set of one or more criteria is satisfied, displaying, via the one or more display generation components, a prompt to confirm performance of the set of one or more actions; and in accordance with a determination that the first set of one or more criteria is not satisfied, displaying, via the one or more display generation components, an indication corresponding to performance of the set of one or more actions without displaying the prompt.

In some embodiments, a transitory computer-readable storage medium storing one or more programs configured to be executed by one or more processors of a computer system that is communication with one or more input devices and one or more display generation components is described. In some embodiments, the one or more programs includes instructions for: while displaying, via the one or more display generation components, a user interface element to perform a set of one or more actions, detecting, via the one or more input devices, an input corresponding to the user interface element; and in response to detecting the input corresponding to the user interface element to perform the set of one or more actions: in accordance with a determination that a first set of one or more criteria is satisfied, displaying, via the one or more display generation components, a prompt to confirm performance of the set of one or more actions; and in accordance with a determination that the first set of one or more criteria is not satisfied, displaying, via the one or more display generation components, an indication corresponding to performance of the set of one or more actions without displaying the prompt.

In some embodiments, a computer system that is communication with one or more input devices and one or more display generation components is described. In some embodiments, the computer system that is communication with one or more input devices and one or more display generation components comprises one or more processors and memory storing one or more programs configured to be executed by the one or more processors. In some embodiments, the one or more programs includes instructions for: while displaying, via the one or more display generation components, a user interface element to perform a set of one or more actions, detecting, via the one or more input devices, an input corresponding to the user interface element; and in response to detecting the input corresponding to the user interface element to perform the set of one or more actions: in accordance with a determination that a first set of one or more criteria is satisfied, displaying, via the one or more display generation components, a prompt to confirm performance of the set of one or more actions; and in accordance with a determination that the first set of one or more criteria is not satisfied, displaying, via the one or more display generation components, an indication corresponding to performance of the set of one or more actions without displaying the prompt.

In some embodiments, a computer system that is communication with one or more input devices and one or more display generation components is described. In some embodiments, the computer system that is communication with one or more input devices and one or more display generation components comprises means for performing each of the following steps: while displaying, via the one or more display generation components, a user interface element to perform a set of one or more actions, detecting, via the one or more input devices, an input corresponding to the user interface element; and in response to detecting the input corresponding to the user interface element to perform the set of one or more actions: in accordance with a determination that a first set of one or more criteria is satisfied, displaying, via the one or more display generation components, a prompt to confirm performance of the set of one or more actions; and in accordance with a determination that the first set of one or more criteria is not satisfied, displaying, via the one or more display generation components, an indication corresponding to performance of the set of one or more actions without displaying the prompt.

In some embodiments, a computer program product is described. In some embodiments, the computer program product comprises one or more programs configured to be executed by one or more processors of a computer system that is communication with one or more input devices and one or more display generation components. In some embodiments, the one or more programs include instructions for: while displaying, via the one or more display generation components, a user interface element to perform a set of one or more actions, detecting, via the one or more input devices, an input corresponding to the user interface element; and in response to detecting the input corresponding to the user interface element to perform the set of one or more actions: in accordance with a determination that a first set of one or more criteria is satisfied, displaying, via the one or more display generation components, a prompt to confirm performance of the set of one or more actions; and in accordance with a determination that the first set of one or more criteria is not satisfied, displaying, via the one or more display generation components, an indication corresponding to performance of the set of one or more actions without displaying the prompt.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for displaying controls, thereby increasing the effectiveness, efficiency, and user satisfaction with such devices. Such processes and interfaces may complement or replace other processes for displaying controls.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6O illustrate exemplary user interfaces for displaying controls in accordance with some embodiments.

FIG. 7 is a flow diagram illustrating a process for displaying controls in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for displaying controls. For example, controls can be displayed that cause different devices to perform different operations or the same operation. Such techniques can reduce the cognitive burden on a user who uses such controls, thereby enhancing productivity. Further, such techniques can reduce processor and battery power otherwise wasted on redundant user inputs.

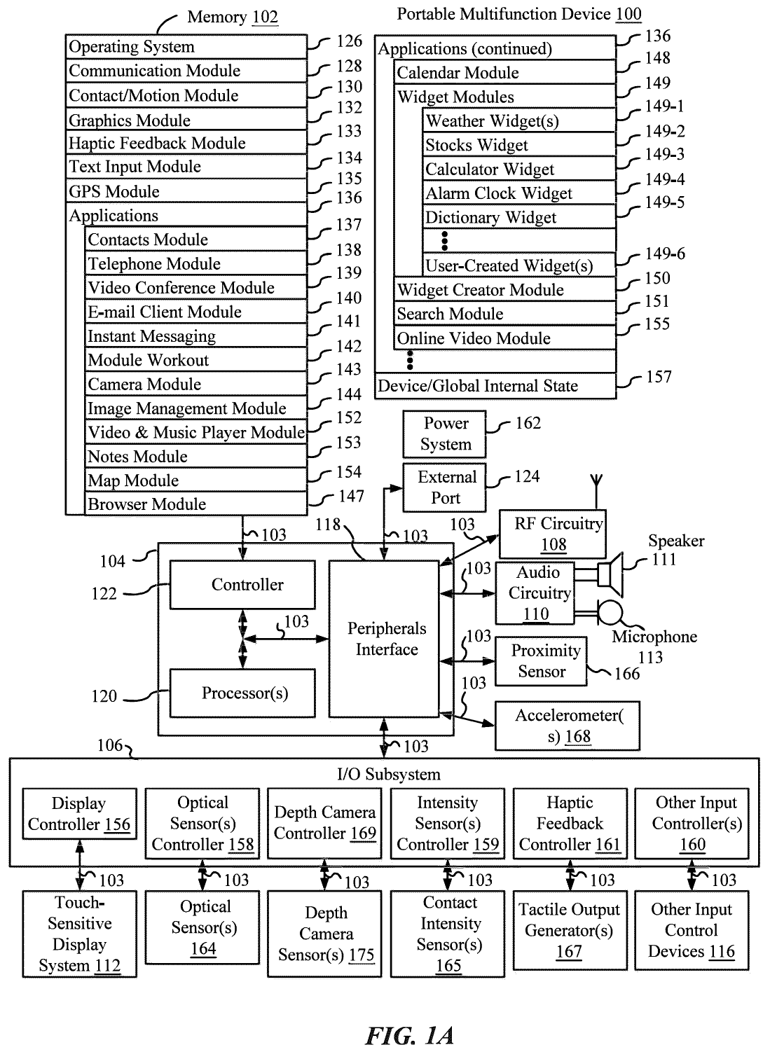

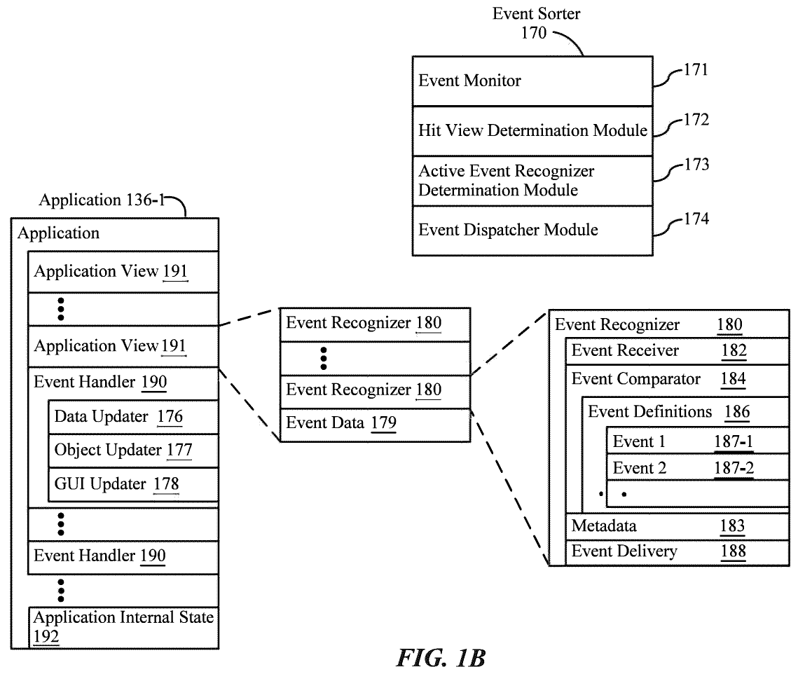

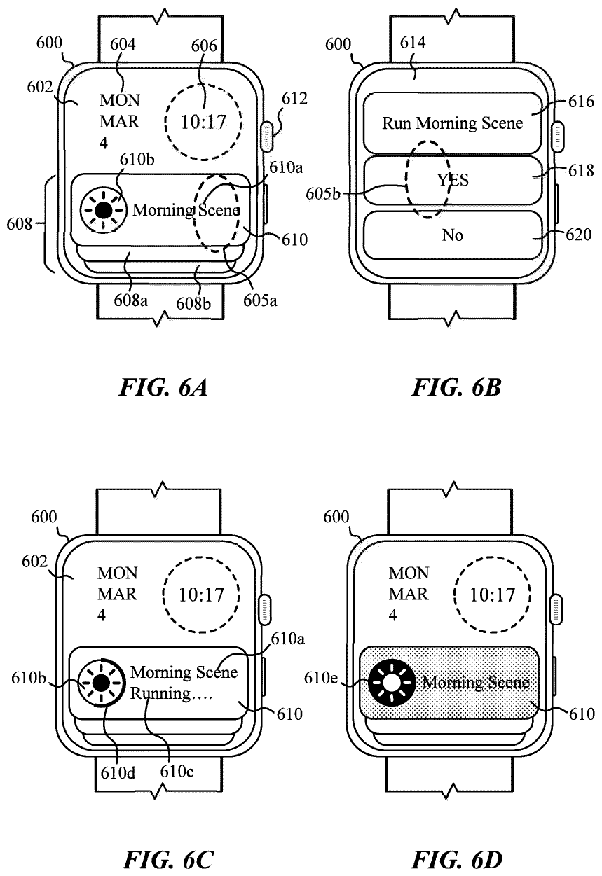

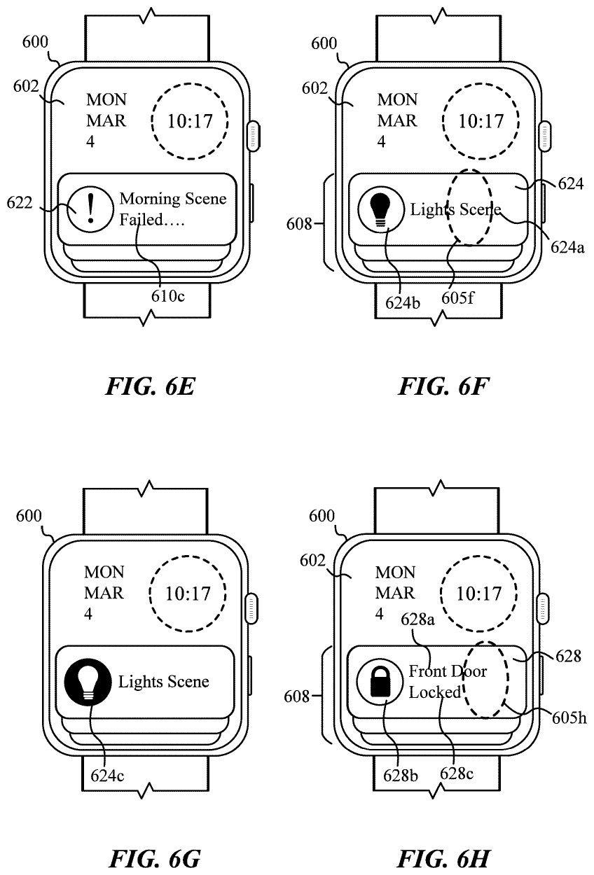

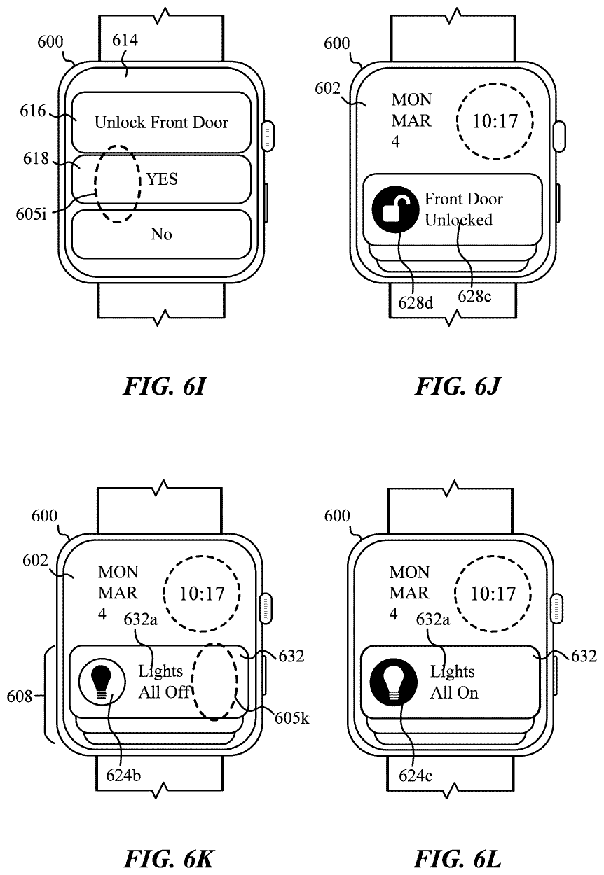

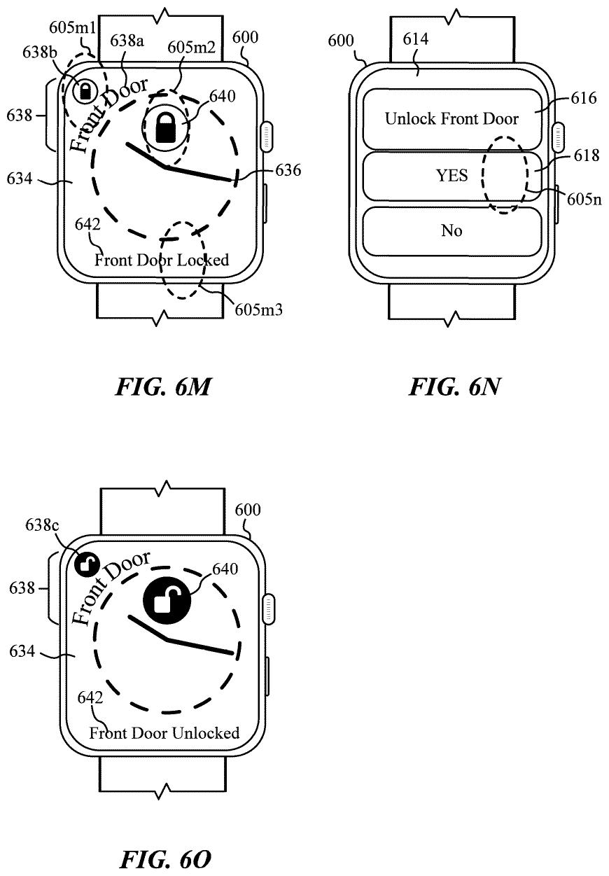

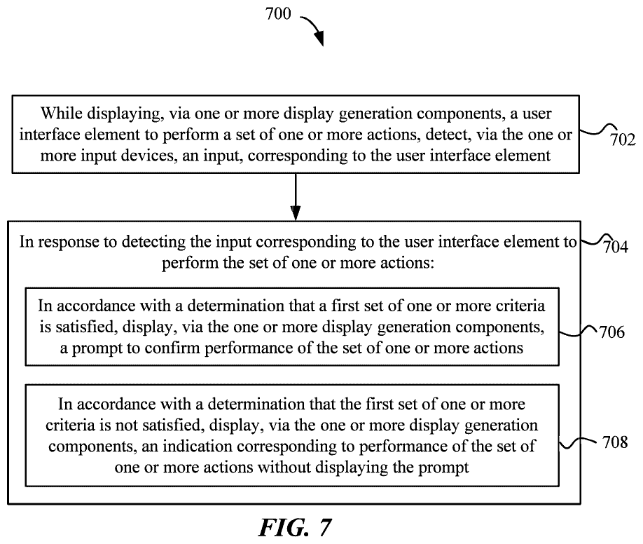

Below, FIGS. 1A-1B, 2, 3A-3G, 4A-4B, and 5A-5B provide a description of exemplary devices for performing the techniques for displaying controls. FIGS. 6A-6O illustrate exemplary user interfaces for displaying controls in accordance with some embodiments. FIG. 7 is a flow diagram illustrating a process for displaying controls in accordance with some embodiments. The user interfaces in FIGS. 6A-6O are used to illustrate the processes described below, including the processes in FIG. 7.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

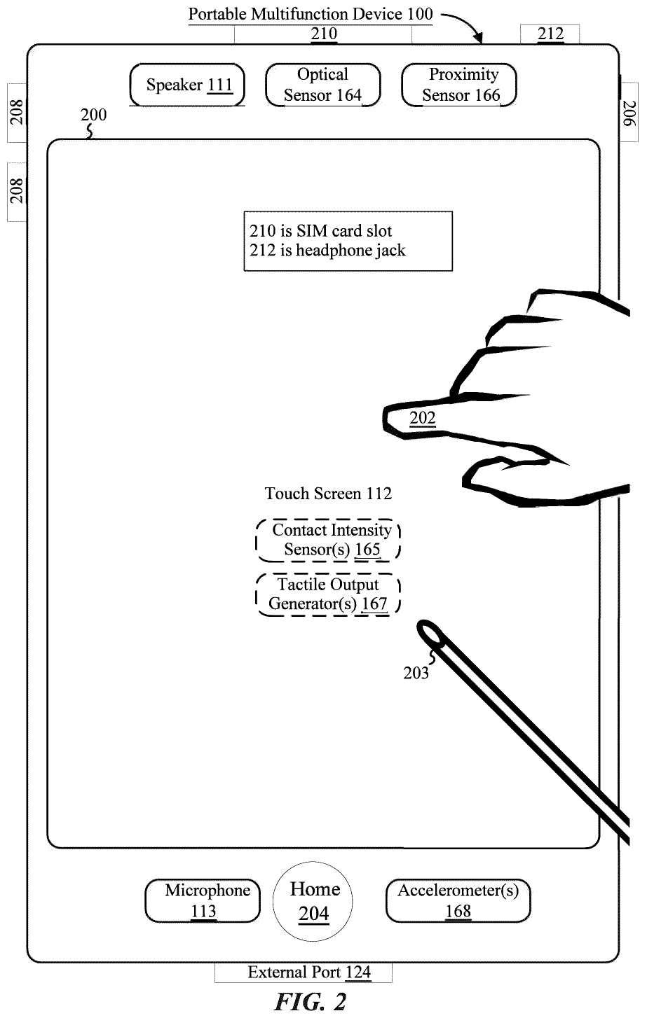

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patents application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

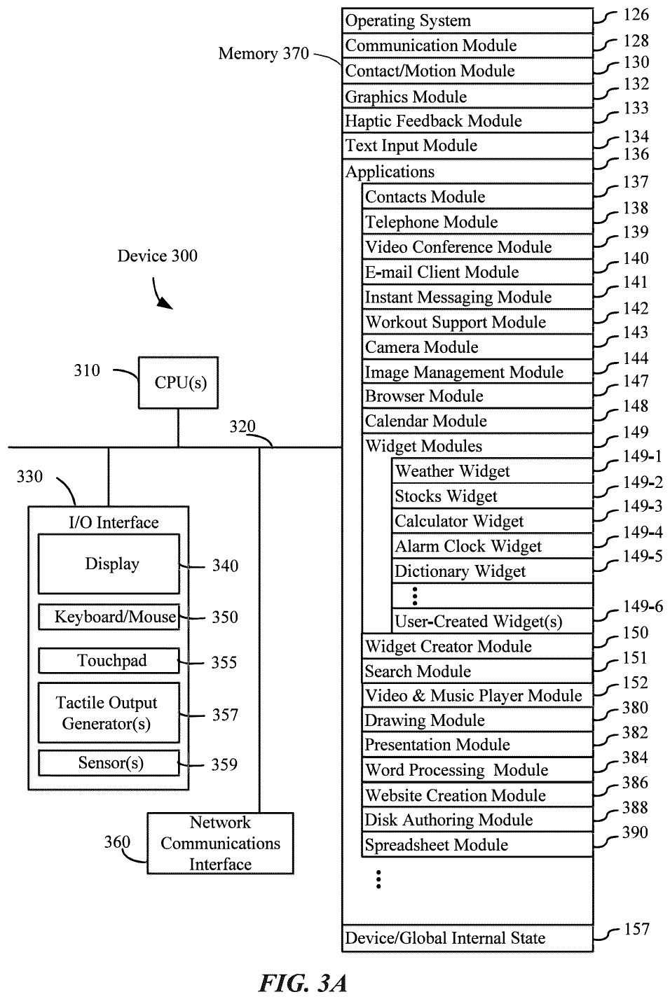

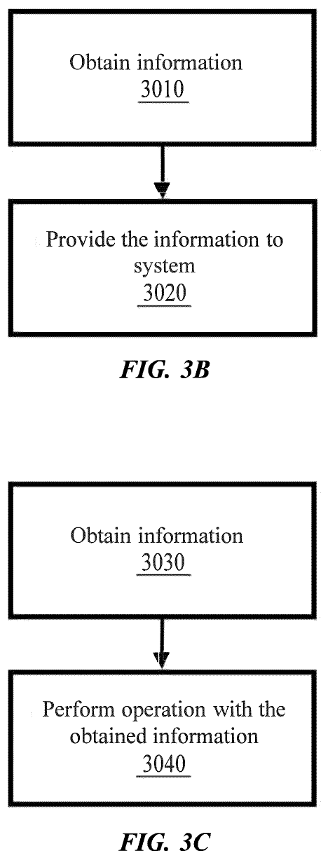

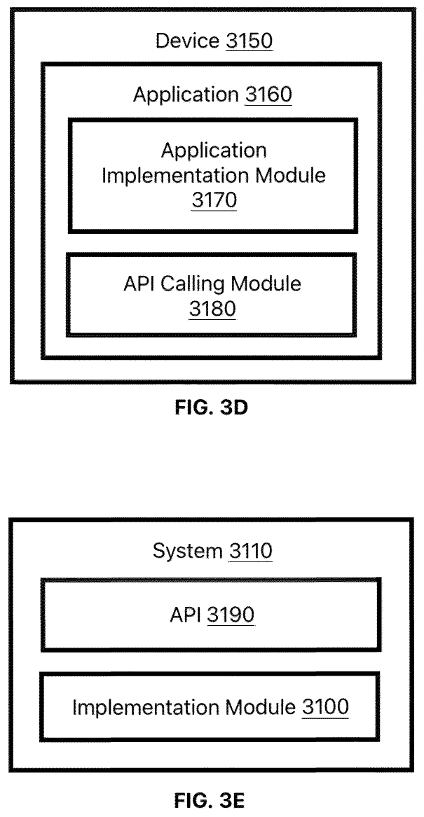

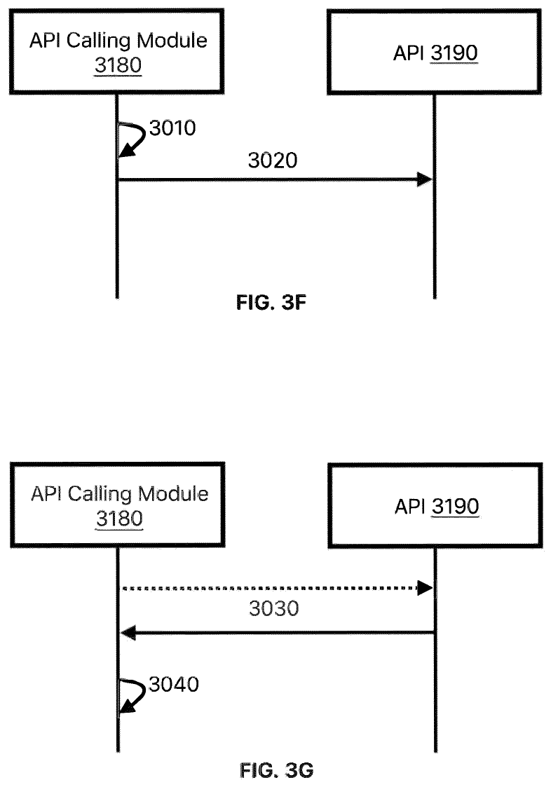

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch” /multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform process 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

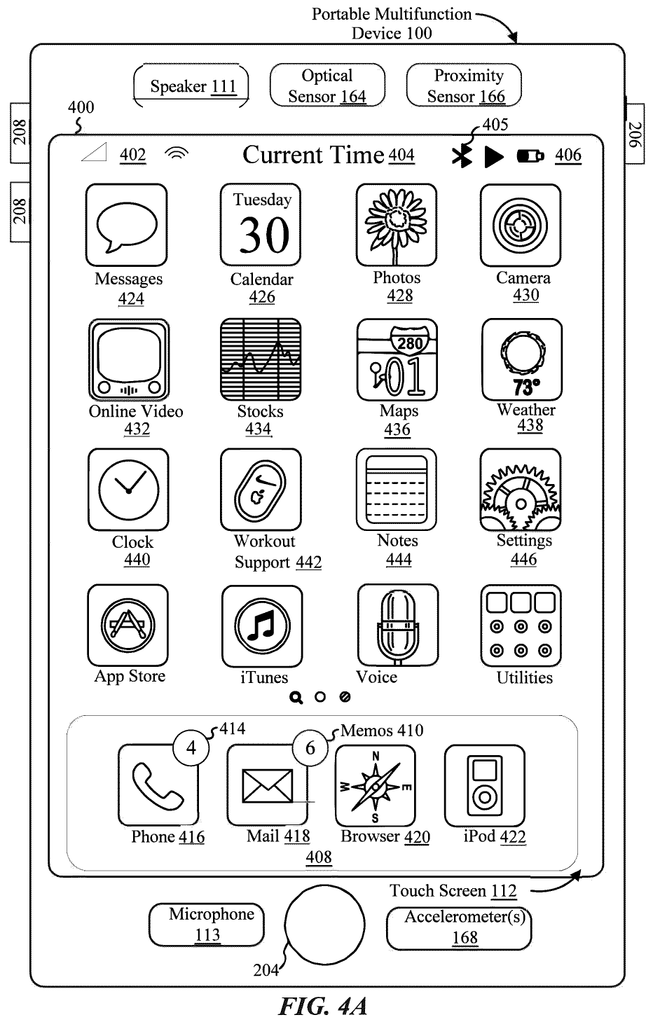

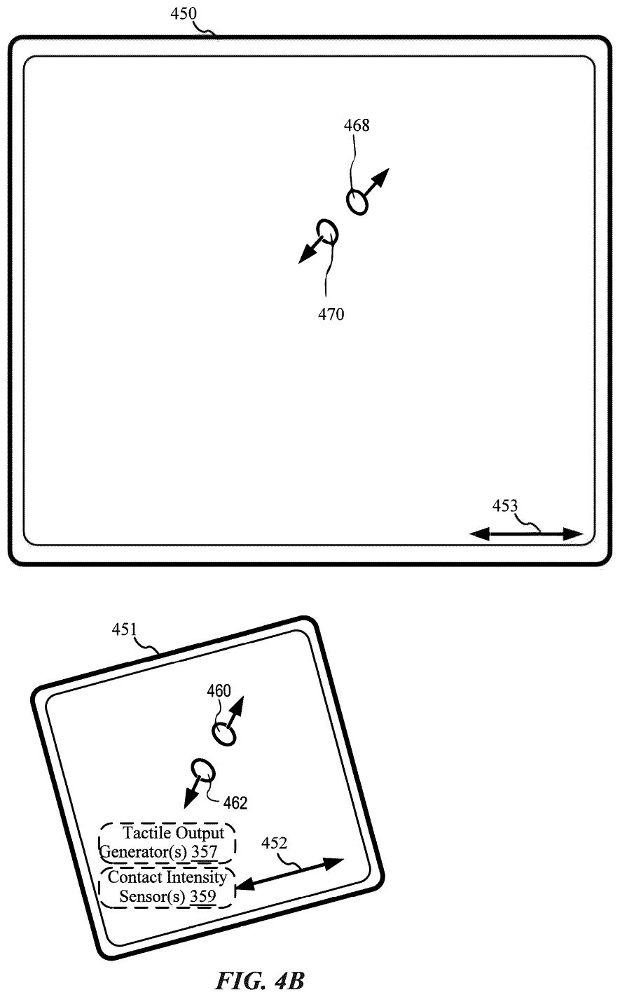

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

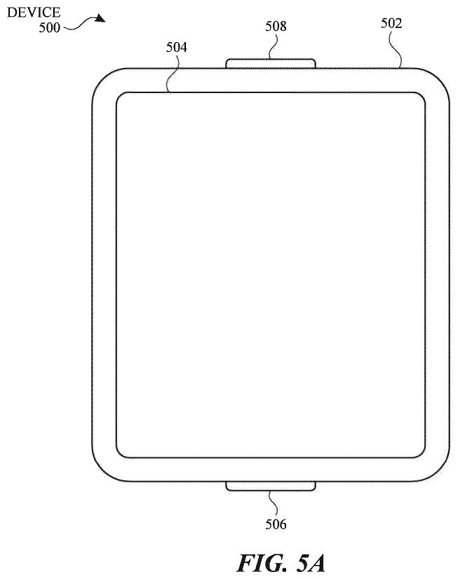

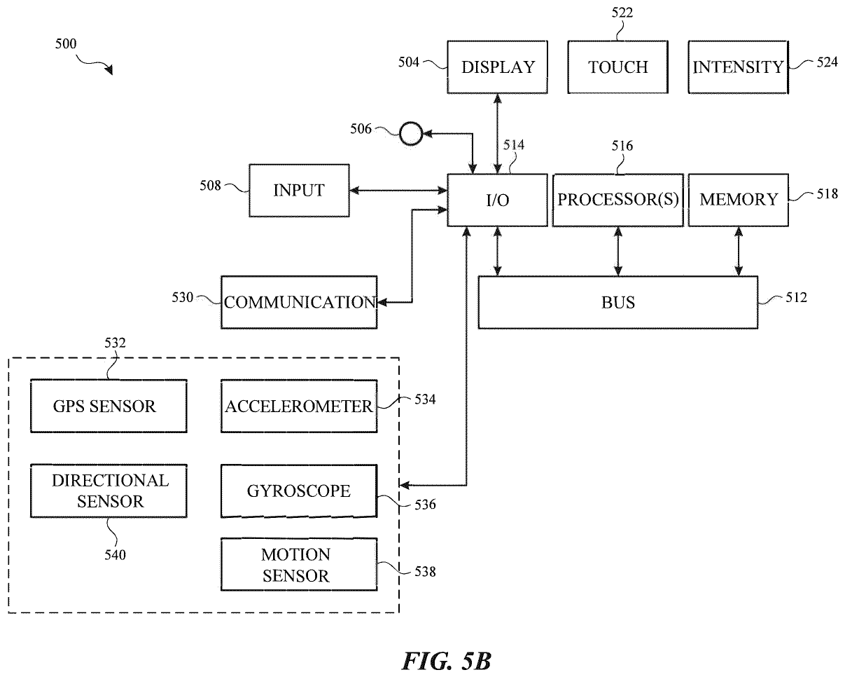

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6O illustrate exemplary user interfaces for displaying controls in accordance with some embodiments. The user interfaces in these figures are used to illustrate the processes described below, including the processes in FIG. 7.

FIGS. 6A-6O illustrate computer system 600 as a smart watch displaying different user interface objects. It should be recognized that computer system 600 can be other types of computer systems such as a smart phone, a tablet, a laptop, a communal device, an accessory, a personal gaming system, a desktop computer, a fitness tracking device, and/or a head-mounted display (HMD) device. It should be recognized that, while some embodiments described herein refer to inputs being tap inputs detected via a touch-sensitive surface, other types of inputs can be used with techniques described herein, such as voice inputs that are detected via one or more microphones and/or air gestures detected via a camera (e.g., a camera that is in communication (e.g., wireless and/or wired communication) with computer system 600.

At FIGS. 6A-6O, computer system 600 is in communication with a smart home control system that monitors a status of and/or coordinates control of smart home accessories (e.g., devices that can be locally managed and/or remotely managed through a secondary device via a network connection). Examples of smart home accessories include lights, speakers, displays (e.g., televisions and/or monitors), security cameras, locks, thermostats, fans, outlets, switches, and/or window coverings. In examples described below, in response to computer system 600 detecting inputs that correspond to requests for the smart home accessories to perform various operations, computer system 600 transmits instructions corresponding to the request to a smart home control system and/or the smart home accessories. In some embodiments, computer system 600 is in communication with the smart home accessories. In some embodiments, in response to computer system 600 detecting inputs that correspond to requests for the smart home accessories to perform various operations, computer system 600 transmits instructions directly to the smart home accessories. At FIGS. 6A-6O, computer system 600 outputs content (e.g., displays) based on determinations regarding a state of the smart home accessories.

At FIGS. 6A-6E, computer system 600 causes different types of accessories to execute a scene. In some embodiments, a scene is a set of one or more operations that various accessories perform in an environment. For example, a scene programmed to be run after a user has left a house can include operations such as turning off lights, ceasing output of music, closing all the shades, and/or locking all the doors. As another example, a morning scene can include increasing the brightness of lights, outputting calming music, and/or opening curtains.

As illustrated in FIG. 6A, computer system 600 displays first watch user interface 602 which includes date indicator 604, small time indicator 606, and selection control 608. Selection control 608 is a scrollable graphical representation of a list of one or more of controls, applications, indications, and/or notifications available on computer system 600. As illustrated in FIG. 6A, computer system 600 displays selection control 608 including morning scene control 610 overlaid on top of first item 608a which is overlaid on top of second item 608b. Morning scene control 610 corresponds to a preconfigured scene that is performed a number of accessories in an environment. In some embodiments, computer system 600 includes morning scene control 610 within selection control 608 based on detecting one or more user inputs.

As illustrated in FIG. 6A, computer system 600 includes rotating mechanism 612. In some embodiments, computer system 600 navigates selection control 608 in response to detecting a rotation of rotating mechanism 612. For example, in response to computer system 600 detecting a rotation input via rotating mechanism 612, computer system 600 displays an alternate item at the top of selection control 608 such as a stopwatch control. In some embodiments, computer system 600 selects morning scene control 610, in response to detecting a depression of rotating mechanism 612 while morning scene control 610 is displayed at the top of selection control 608.

In some embodiments, computer system 600 displays a control for a scene and/or one or more accessories at the top of selection control 608 in response to criteria being satisfied. For example, in response to criteria being satisfied based on a current time being before 10 AM on a weekday (e.g., Monday) and/or a location of computer system 600 being at a home of a user, computer system 600 displays morning scene control 610 at the top of selection control 608. For another example, in response to criteria being satisfied based on a garage door being open for a predetermined period of time, computer system 600 displays a control to close the garage door at the top of selection control 608. As another example, in response to the criteria being satisfied based on computer system 600 being in close proximity to a door, computer system 600 displays a control to unlock and/or lock the door at a top of selection control 608.

As illustrated in FIG. 6A, computer system 600 displays morning scene control 610 with morning scene label 610a occupying a majority of a width of morning scene control 610 and morning scene icon 610b displayed to the left of morning scene label 610a. As illustrated in FIG. 6A, morning scene icon 610b is a circular icon with a light-colored background overlaid by a contrasting and/or darker colored representation of a sun. At FIG. 6A, computer system 600 detects tap input 605a at a location corresponding to morning scene control 610. In some embodiments, instead of tap input 605a, computer system 600 detects a gaze input directed at the location of morning scene control 610, a voice command including an utterance identifying morning scene control 610, a depression of rotating mechanism 612 while morning scene control 610 is visually emphasized, and/or an air gesture directed at morning scene control 610.

At FIG. 6B, a determination is made that running the scene corresponding to morning scene control 610 is not reversable (e.g., one or more operations in the scene, or the collection of operations, is incapable of being run in reverse). As illustrated in FIG. 6B, in response to detecting tap input 605a and based on the determination that running the scene corresponding to morning scene control 610 is not reversable, computer system 600 displays confirmation user interface 614 and ceases displaying first watch user interface 602. As illustrated in FIG. 6B, confirmation user interface 614 includes confirmation statement 616, affirmative response control 618 with the text “yes,” and negative response control 620 with the text “no.” Computer system 600 displays confirmation statement 616 at the top of confirmation user interface 614, affirmative response control 618 in the middle of confirmation user interface 614, and negative response control 620 at the bottom of confirmation user interface 614 with all three occupying the entire width of confirmation user interface 614.

As illustrated in FIG. 6B, computer system 600 displays confirmation statement 616 with text corresponding to morning scene control 610 (e.g., run morning scene). In some embodiments, computer system 600 displays affirmative response control 618 and negative response control 620 with different text, such as “run” for affirmative response control 618 and “do not run” for negative response control 620. In some embodiments, computer system 600 displays affirmative response control 618 and negative response control 620 with symbols instead of text, such as a check mark for affirmative response control 618 and an “X” mark for negative response control 620. At FIG. 6B, computer system 600 detects tap input 605b at a location corresponding to affirmative response control 618. In some embodiments, instead of tap input 605b, computer system 600 detects a gaze input directed at the location of affirmative response control 618, a voice command including an utterance identifying affirmative response control 618, a depression of rotating mechanism 612 while affirmative response control 618 is visually emphasized, and/or an air gesture directed at affirmative response control 618.

At FIG. 6C, in response to detecting tap input 605b, computer system 600 displays first watch user interface 602 and computer system 600 transmits instructions to the smart home control system that causes the smart accessories to perform one or more operations of the morning scene. The scene corresponding to morning scene control 610 can include operations such as gradually turning the brightness of lights up to eighty percent power, outputting a music mix from a set of speakers, and/or opening curtains. In some embodiments, the scene corresponding to morning scene control 610 includes different operations involving different accessories. For example, in some embodiments, morning scene control 610 includes a thermostat turning on the air conditioning, the output of lights gradually brightening to one hundred percent out, and/or a television powering on. In some embodiments, at FIG. 6B, computer system 600 detects a tap input at a location corresponding to negative response control 620 (e.g., and not tap input 605b), resulting in computer system 600 redisplaying first watch user interface 602 without transmitting instructions to the smart home control system. In some embodiments, in response to detecting tap input 605b, computer system 600 transmits the instructions directed to the smart accessories.

At FIG. 6C, a determination is made that the operations corresponding to morning scene control 610 are in the process of being performed (e.g., the operations have not been completed). For example, at FIG. 6C the output of the lights has not reached a preconfigured brightness corresponding to the morning scene. As illustrated in FIG. 6C, based on the determination that the operations corresponding to morning scene control 610 are in the process of being performed, computer system 600 displays scene status indicator 610c under morning scene label 610a with text indicating the status of the operations (e.g., running). In some embodiments, computer system 600 displays scene status indicator 610c under morning scene label 610a with text indicating the status (e.g., running) in response to receiving a status update that the operations corresponding to morning scene control 610 are running.

Also illustrated in FIG. 6C, based on the determination that the operations corresponding to morning scene control 610 are in the process of being performed, computer system 600 displays percentage indicator 610d as a partial circle around the perimeter of morning scene icon 610b. Percentage indicator 610d indicates the status of the operations of the morning scene. For example, if the operations corresponding to the morning scene are sixty percent complete, computer system 600 displays percentage indicator 610d around sixty percent of the perimeter of morning scene icon 610b.

At FIG. 6D, a determination is made that the operations that correspond to morning scene control 610 have been completed. As illustrated in FIG. 6D, based on the determination that the operations that correspond to morning scene control 610 have been completed, computer system 600 displays morning scene complete icon 610e in place of morning scene icon 610b. Morning scene complete icon 610e is the same size and shape as morning scene icon 610b. The colors included in morning scene complete icon 610e are inverted with respect to the colors of morning scene icon 610b (e.g., morning scene complete icon 610e includes a background color that is the same color as the sun representation within morning scene icon 610b and a sun representation that is the same color as the background color of morning scene icon 610b). In some embodiments, the appearance of morning scene complete icon 610e indicates that the scene that corresponds to morning scene control 610 is not reversible.

At FIG. 6D, based on the determination that the operations that correspond to morning scene control 610 have been completed, computer system 600 ceases displaying scene status indicator 610c and percentage indicator 610d and displays morning scene control 610 as greyed out. As illustrated in FIG. 6D, computer system 600 displays the body of morning scene control 610 as greyed out. Computer system 600 displays the body of morning scene control 610 as greyed to indicate to that morning scene control 610 is no longer selectable. At FIG. 6D, morning scene control 610 is no longer selectable because the operations that correspond to morning scene control 610 are not reversible.

FIG. 6E depicts a situation where instead of a determination being made that operations corresponding to morning scene control 610 have run to completion (e.g., as described with respect to FIG. 6D) a determination is made that that one or more operations corresponding to morning scene control 610 have failed to run to completion. Reasons one or more operations may fail to run to completion include a motor jamming, an accessory not responding, a loss of connection, and/or a power failure. As illustrated in FIG. 6E, based on the determination that one or more operations corresponding to morning scene control 610 have failed to run to completion, computer system 600 displays incident icon 622 and scene status indicator 610c with text indicating the failure (e.g., failed).

Incident icon 622 is an indication that one or more operations for the selected scene failed to run to completion. As illustrated in FIG. 6E, incident icon 622 is a circle icon with an exclamation mark in the middle. Computer system 600 displays incident icon 622 at the same location as morning scene icon 610b in FIG. 6A.

At FIGS. 6F-6G, computer system 600 causes a single type of accessory to run a scene. In particular, the scene involves causing multiple lights to perform different operations. In some embodiments, the scene involves controlling a different type of accessory other than lights. In some embodiments, computer system 600 is in communication with the multiple lights.

As illustrated in FIG. 6F, computer system 600 displays first watch user interface 602 with lights scene control 624 as the top item in selection control 608. In some embodiments, computer system 600 displays lights scene control 624 as the top item in selection control 608 based on computer system 600 being in close proximity to the multiple lights associated with lights scene control 624. For example, lights scene control 624 corresponds to all the lights in a living room of a user, and computer system 600 displays lights scene control 624 as the top item within selection control 608 due to the user entering the living room.

As illustrated in FIG. 6F, lights scene control 624 includes lights scene label 624a occupying the majority of the width of light scene control 624 and first state light icon 624b displayed to the left of light scene label 624a. First state light icon 624b is a circular icon with a light-colored background overlaid by a contrasting and/or darker colored representation of a light bulb. As illustrated in FIG. 6F, computer system 600 displays first state light icon 624b as the same size, shape, and location as computer system 600 displayed morning scene icon 610b in FIG. 6A. At FIG. 6F, computer system 600 detects tap input 605f at a location corresponding to lights scene control 624. In some embodiments, instead of tap input 605f, computer system 600 detects a gaze input directed at the location of lights scene control 624, a voice command including an utterance identifying lights scene control 624, a depression of rotating mechanism 612 while lights scene control 624 is visually emphasized, and/or an air gesture directed at lights scene control 624.

At FIG. 6G, in response to detecting tap input 605f, computer system 600 transmits instructions to the smart home control system that cause the multiple lights to run various operations corresponding to lights scene control 624. In this example, the scene corresponding to lights scene control 624 includes operations of turning on a set of front porch lights to a power level of forty percent, turning on office lights to a power level of eighty percent, and turning on the dining room lights to a power level of seventy percent.

At FIG. 6G, a determination is made that the operations corresponding to light scene control 624 have completed. As illustrated in FIG. 6G, based on the determination that the operations corresponding to light scene control 624 have completed, computer system 600 ceases to display first state light icon 624b and displays second state light icon 624c. The colors included in second state light icon 624c are inverted with respect to the colors of first state light icon 624b (e.g., second state light icon 624c includes a background color that is the same color as the color of the light bulb representation within first state light icon 624b and a light bulb representation of second state light icon 624c is the same color as the background color of first state light icon 624b). In some embodiments, a determination is made that the operations corresponding to lights scene control 624 are running. In such embodiments, based on the determination that the operations corresponding to light scene control 624 are running, computer system 600 displays scene status indicator 610c with text indicating the status (e.g., running) of the operations and displays percentage indicator 610d as a percentage of a circle around second state light icon 624c. In some embodiments, a determination is made that the operations corresponding to lights scene control 624 failed to run to completion. In such embodiments, computer system 600 displays incident icon 622 and displays scene status indicator 610c with text indicating the failure. In some embodiments, computer system 600 ceases to display first state light icon 624b and displays second state light icon 624c in response to receiving a status update that the operations corresponding to lights scene control 624 are complete. In some embodiments, computer system 600 displays incident icon 622 and scene status indicator 610c with an indication that the operations have failed to run to completion in response to receiving a status update that the operations corresponding to lights scene control 624 did not run to completion.

Please note that, based on a determination that the scene corresponding to lights scene control 624 is reversable, computer system 600 does not display confirmation user interface 614 in response to detecting tap input 605f. Also, once the operations corresponding to lights scene control 624 have run to completion, based on a determination that the scene corresponding to lights scene control 624 is reversible, computer system 600 continues to display lights scene control 624 as selectable (e.g., not greyed out). In some embodiments, after the operations corresponding to lights scene control 624 have run to completion, computer system 600 detects a second tap input at a location corresponding to lights scene control 624. In some embodiments, in response to detecting the second tap input, computer system 600 transmits instructions (e.g., to the multiple lights and/or the smart home control system) that cause the multiple lights to revert to their previous state before the operations corresponding to lights scene control 624 were performed.

FIGS. 6H-6J illustrate a process of computer system 600 controlling a front door lock. Unlike controlling the scenes described above (e.g., FIGS. 6A-6G), which involve controlling multiple accessories, this is a scenario involving controlling a single accessory. In some embodiments, the accessory is a different means of entry, such as a back door, or a garage door.

As illustrated in FIG. 6H, computer system 600 displays first watch user interface 602 with door lock control 628 as the top item in selection control 608. Door lock control 628 includes door lock label 628a occupying a majority of the width of door lock control 628. Door lock control 628 corresponds to a front door of a home of the user. In some embodiments, computer system 600 displays door lock control 628 as the top item in selection control 608 based on a determination that computer system 600 is in close proximity to the front door. In some embodiments, computer system 600 displays door lock control 628 as the top item in selection control 608 based on the state of the front door (e.g., the front door is unlocked or the front door is locked).

At FIG. 6H, a determination is made that the front door is locked. As illustrated in FIG. 6H, based on the determination that the front door is locked, computer system 600 displays locked icon 628b to the left of door lock label 628a and computer system 600 displays lock status indicator 628c below door lock label 628a with text indicating that the front door is locked. Locked icon 628b is a circular icon with a light-colored background overlayed by a contrasting and/or darker colored representation of a lock in the locked position to indicate that the front door is locked. In some embodiments, computer system 600 displays locked icon 628b to the left of door lock label 628a in response to computer system 600 receiving a status update that the front door is locked. Computer system 600 displays locked icon 628b as the same size, shape, and at the same location as computer system 600 displayed morning scene icon 610b in FIG. 6C. At FIG. 6H, computer system 600 detects tap input 605h at a location corresponding to door lock control 628. In some embodiments, instead of tap input 605h, computer system 600 detects a gaze input directed at the location of door lock control 628, a voice command including an utterance identifying door lock control 628, a depression of rotating mechanism 612 while door lock control 628 is visually emphasized, and/or an air gesture directed at door lock control 628.

At FIG. 6I, a determination is made that unlocking the front door remotely (e.g., unlocking from computer system 600 instead of manually unlocking the front) is a security risk. As illustrated in FIG. 6I, based on the determination that unlocking the front door remotely is a security risk and in response to detecting tap input 605h, computer system 600 displays confirmation user interface 614 and ceases displaying first watch user interface 602. That is, the front door is a secure type of accessory that secures individuals and/or possessions within a home. Accordingly, before unlocking the front door, computer system 600 seeks confirmation that the user would indeed like to unlock the front door. That is, in some embodiments, computer system 600 displays confirmation user interface 614 when operations of a selected scene are not reversible (e.g., as described above at FIG. 6B) or when the accessory that corresponds to the scene is a secure type of accessory.

Confirmation user interface 614 includes confirmation statement 616 with text corresponding to door lock control 628 (e.g., unlock front door), affirmative response control 618, and negative response control 620. At FIG. 6I, computer system 600 detects tap input 605i at a location corresponding to affirmative response control 618. In some embodiments, instead of tap input 605i, computer system 600 detects a gaze input directed at the location of affirmative response control 618, a voice command including an utterance identifying affirmative response control 618, a depression of rotating mechanism 612 while affirmative response control 618 is visually emphasized, and/or an air gesture directed at affirmative response control 618.

At FIG. 6J, in response to detecting tap input 605i, computer system 600 transmits instructions to the smart home control system that cause the lock of the front door to unlock itself and displays first watch user interface 602. At FIG. 6J, a determination is made that the front door is unlocked. As illustrated in FIG. 6J, based on the determination that that the front door is unlocked, computer system 600 displays unlocked icon 628d in place of locked icon 628b. Unlocked icon 628d is the same size and shape of locked icon 628b and includes a color scheme that is the inverse of the color scheme of locked icon 628b (e.g., the background color of unlocked icon 628d is the same color as the color of the lock representation in locked icon 628b and the representation of lock in unlocked icon 628d that is the same color as the background color of locked icon 628b).

As illustrated in FIG. 6J, based on the determination that the front door is unlocked, computer system 600 displays lock status indicator 628c with text indicating that the front door is unlocked. In some embodiments, at FIG. 6I, computer system 600 detects a tap input at a location corresponding to negative response control 620. In some embodiments, in response to computer system 600 detecting the tap input at the location corresponding to negative response control 620, computer system 600 redisplays first watch user interface 602 without transmitting instructions that cause the lock of the front door to unlock itself.

FIGS. 6K-6L illustrate a process of computer system 600 uniformly controlling a group of lights. Unlike controlling the lights scene above (e.g., FIGS. 6F-6G) which involved different lights performing different operations, this scenario involves multiple lights performing the same operation. In some embodiments, a single instruction is sent to one or more of a different type of accessory.

As illustrated in FIG. 6K, computer system 600 is displays first watch user interface 602 with lights control 632 as the top item in selection control 608. Lights control 632 includes lights control label 632a at the center of lights control 632. At FIG. 6K, computer system 600 a determination is made that one or more lights in the group of lights corresponding to lights control 632 are powered on. Based on the determination that one or more lights in the group of lights corresponding to lights control 632 are on, computer system 600 displays lights control label 632a with the text indicating that a tap input corresponding to lights control 632 will result in the lights being turned off (e.g., all off). Also illustrated in FIG. 6K, based on the determination that one or more lights in the group of lights corresponding to lights control 632 are powered on, computer system 600 displays first state light icon 624b to the left of lights control label 632a. At FIG. 6K, computer system 600 detects tap input 605k at a location corresponding to lights control 632. In some embodiments, instead of tap input 605k, computer system 600 detects a gaze input directed at the location of lights control 632, a voice command including an utterance identifying lights control 632, a depression of rotating mechanism 612 while lights control 632 is visually emphasized, and/or an air gesture directed at lights control 632.

At FIG. 6L, in response to detecting tap input 605k, computer system 600 transmits instructions to the smart home control system that cause all the lights in the group of lights to power off (e.g., turn off all lights that are in the group that are on so that all lights in the group are in an off state) to the smart home control system. At FIG. 6L, a determination is made that turning off the lights corresponding to lights control 632 is not a security risk. Because a determination is made that that turning off the lights corresponding to lights control 632 is not a security risk, computer system 600 does not display confirmation user interface 614 in response to detecting tap input 605k. In some embodiments, computer system 600 does not display confirmation user interface 614 based on a determination that the operation of powering off all the lights is reversible. In some embodiments, in response to detecting tap input 605k, computer system 600 transmits instructions to the group of lights that cause the group of lights to power off.

At FIG. 6L, a determination is made that the lights included in the group of lights corresponding to lights control 632 are turned off. As illustrated in FIG. 6L, based on the determination that the lights included in the group of lights corresponding to lights control 632 are turned off, computer system 600 displays lights control label 632a with the text indicating that an input corresponding to lights control 632 will result in the lights being turned on (e.g., all on) and replaces first state light icon 624b with second state light icon 624c.

At FIGS. 6M-6O depicts an alternative manner of computer system 600 unlocking, via the smart home control system, the front door lock. At FIGS. 6M-6O, instead of computer system 600 displaying door lock control 628 within selection control 608, computer system 600 displays various complications (e.g., a function in a standard watch face other than telling time) for unlocking the front door. More specifically, FIGS. 6M and 6O illustrate computer system 600 displaying three different types of complications for unlocking the front door at various locations.

As illustrated in in FIG. 6M, computer system 600 displays second watch user interface 634 including large time indicator 636 which resembles a circular watch face with minute and hour hands joining at a center point within second watch user interface 634. FIG. 6M illustrates three possible styles and locations of front door control complications, including corner complication 638, center complication 640, and lower complication 642. In some embodiments, second watch user interface 634 does not include each of corner complication 638, center complication 640, and lower complication 642. For example, in some embodiments, second watch user interface 634 includes one of corner complication 638, center complication 640, and lower complication 642. In some embodiments, the appearance of corner complication 638, center complication 640, and/or lower complication 642 is based on the location that computer system 600 displays the complication within second watch user interface 634. For example, corner complication 638 has a different appearance when computer system 600 displays corner complication 638 in the upper right corner of second watch user interface 634 in contrast to when computer system 600 displays corner complication 638 in the upper left corner of second watch user interface 634. In some embodiments, the location that computer system 600 displays corner complication 638, center complication 640, and/or lower complication 642 within second watch user interface 634 is selected by the user. In some embodiments, corner complication 638, center complication 640, and/or lower complication 642 corresponds to running a scene and/or altering the state of one or more accessories other than a door lock. In some embodiments, computer system 600 includes corner complication 638, center complication 640, and lower complication 642 within second watch user interface 634 in response to detecting one or more inputs from a user.

As illustrated in FIG. 6M, corner complication 638 is located at the top left corner of second watch user interface 634 and includes corner complication label 638a with text following the curve of large time indicator 636. At FIG. 6M, a determination is made that the front door is locked. As illustrated in FIG. 6M, based on the determination that the front door is locked, computer system 600 displays locked corner icon 638b within the upper left corner of corner complication 638. Locked corner icon 638b is a smaller version of locked icon 628b in that it is a circular icon with a light-colored background overlaid by the dark-colored representation of a lock in a locked position to indicate that the front door is locked.

Also illustrated in FIG. 6M, computer system 600 displays center complication 640 as a circular icon. At FIG. 6M, based on the determination that the front door is locked, computer system 600 displays center complication 640 with a light-colored background overlaid by the dark-colored representation of a lock in a locked position to indicate that the front door is locked.

As illustrated in FIG. 6M, computer system 600 displays lower complication 642 below the large time indicator 636, centered at the bottom of second watch user interface 634. Lower complication 642 includes text indicating the state of the front door. As illustrated in FIG. 6M, based on the determination that the front door is locked, computer system 600 displays lower complication 642 with the text “locked” to indicate that the front door is locked. At FIG. 6M, computer system 600 detects a tap input on a location corresponding to one of corner complication 638, center complication 640, or lower complication 642 (e.g., 605m1 corresponds to a location of corner complication 638, 605m2 corresponds to a location of center complication 640, and 605m3 corresponds to a location of lower complication 642).

At FIG. 6N, a determination is made that remotely unlocking the front door is a security risk. As illustrated in FIG. 6N, in response to detecting the tap input (e.g., 605m1, 605m2, and/or 605m3) and based on the determination that remotely unlocking the front door is a security risk, computer system 600 displays confirmation user interface 614 and ceases displaying second watch user interface 634. Confirmation user interface 614 includes confirmation statement 616 with text corresponding to the operation to be performed to the front door (e.g., unlock front door). Please note, computer system 600 had the same reaction in FIG. 6I in response to detecting tap input 605h. At FIG. 6N, computer system 600 detects tap input 605n at a location corresponding to affirmative response control 618. In some embodiments, instead of tap input 605n, computer system 600 detects a gaze input directed at the location of affirmative response control 618, a voice command including an utterance identifying affirmative response control 618, a depression of rotating mechanism 612 while affirmative response control 618 is visually emphasized, and/or an air gesture directed at affirmative response control 618.

At FIG. 6O, in response to response to detecting tap input 605n, computer system 600 transmits instructions to the smart home control system that cause the lock of the front door to unlock itself and computer system 600 displays second watch user interface 634. At FIG. 6O, a determination is made that the front door is unlocked. As illustrated in FIG. 6O, based on the determination that the front door is unlocked, computer system 600 displays unlocked corner icon 638c in-place of locked corner icon 638b. Unlocked corner icon 638c is a smaller version of unlocked icon 628d in that it is a circular icon with a dark-colored background overlayed by a light-colored representation of a lock in an unlocked position indicating that the front door is unlocked. Also illustrated in FIG. 6O, based on the determination that the front door is unlocked, computer system 600 displays center complication 640 as a circular icon with a dark-colored background overlaid by a light-colored representation of a lock in an unlocked position indicating that the front door is unlocked. Lastly, as illustrated in FIG. 6O, based on the determination that the front door is unlocked, computer system 600 displays lower complication 642 with the text “front door unlocked” to indicate the state of the front door.

It should be recognized that an input to lock the front door might not require a confirmation user interface as it is determined that locking the front door is not a security risk. Accordingly, the same control can have different behavior with respect to requiring a confirmation user interface depending on whether it is determined that one way is a security risk and another way is not a security risk.

In some embodiments, the color scheme of an icon (e.g., morning scene icon 610b, morning scene complete icon 610e, incident icon 622, first state light icon 624b, second state light icon 624c, locked icon 628b, unlocked icon 628d, locked corner icon 638b, unlocked corner icon 638c, and/or center complication 640) is different than what is described above. In some embodiments, the color scheme of an icon is a default color scheme selected by computer system 600. In some embodiments, the color scheme of an icon is selected by the user. In some embodiments, the shape of the representation within an icon is a default shape selected by computer system 600. In some embodiments, the shape of the representation within an icon is selected by the user.

In some embodiments, computer system 600 outputs a sound notification based a state of an accessory. For example, based on a determination that the front door transitions from an unlocked state to a locked state, computer system 600 outputs a sound resembling a lock locking. For another example, based on a determination that one or more operations corresponding to the morning scene have failed to run to completion, computer system 600 outputs a horn noise. In some embodiments, based on a status of one or more operations of a scene and/or an accessory, computer system 600 outputs haptic feedback.

FIG. 7 is a flow diagram illustrating a process (e.g., process 700) for displaying controls in accordance with some embodiments. Some operations in process 700 are, optionally, combined, the orders of some operations are, optionally, changed, and some operations are, optionally, omitted.

As described below, process 700 provides an intuitive way for displaying controls. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) (e.g., a watch, a phone, a tablet, a fitness tracking device, a processor, a head-mounted display (HMD) device, a communal device, a media device, a speaker, a television, and/or a personal computing device) that is communication with one or more input devices (e.g., 612) (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is in communication with one or more accessory devices (e.g., smart speaker, communal device, smart tv, audio visual equipment, network control device, outlet, camera, home condition system, another computer system, head-mounted display, and/or network connected device). In some embodiments, the computer system is in communication with one or more accessory devices via a hub device. In some embodiments, the audio-visual equipment is an audio-visual receiver, speakers and/or tv. In some embodiments, the network control device is a hub device, modem, router, and/or network access points. In some embodiments, the home condition system is an air conditioner, thermostat, and/or heater. In some embodiments, the network connected device is a light, appliance, lock, garage door, and/or device to control a physical object. In some embodiments, the physical object are blinds, a pet accessory and/or a window.

While displaying, via the one or more display generation components, a user interface element (e.g., 610, 624, 628, 632, 638, 640, 642) (e.g., icons, widgets, controls, and/or windows) to perform (and/or request to perform) a set of one or more actions (and/or via one or more accessory devices) (and/or via the computer system) (e.g., controlling and/or altering the state of (e.g., power state, output, and/or initiating a process and/or action) another device, accessory, and/or network connected device), the computer system detects (702), via the one or more input devices (e.g., 612), an input (e.g., 605a, 605f, 605h, 605k, 605m1, 605m2, and/or 605m3) (e.g., a selection input and/or a non-selection input) corresponding to (e.g., directed to, on, and/or selecting) the user interface element. In some embodiments, the computer system displays the user interface element in response to detecting: (1) a condition corresponding to a user (e.g., an input from a user, a user preference, a user's position relative to an accessory device, and/or a user's habits), (2) a position of the computer system (e.g., proximity to an accessory device and/or relevant position, a setting stored on the computer system, and/or detected condition), and/or (3) a state of one or more of the accessory devices (e.g., time since turned on and/or off, connectivity, relevant devices, and/or regular use). In some embodiments, the user interface element represents the one or more actions (e.g., includes a representation of an accessory device corresponding to an action such as a light for a set of light actions, a representation of the one or more actions together such as a home representation for a set of lock actions, and/or a representation of context around the one or more actions such as a rising sun for a set of morning actions and/or moon for a set of evening actions). In some embodiments, the computer system continuously displays the user interface element to perform the set of one or more actions (e.g., at a fixed position, displayed alongside other content, and/or continuously accessible). In some embodiments, the user's habits include the user always playing music upon waking up, opening blinds in the evening, and/or locking all locks before going to bed. In some embodiments, the relevant position is near a door and/or in a driveway near a door. In some embodiments, the setting stored on the computer system causes the computer system to always turn off lights at 8 pm. In some embodiments, the detected condition corresponds to a weather, time, and/or connectivity. In some embodiments, the relevant devices are lights and/or locks in the evening.

In response to (704) detecting the input (e.g., 605a, 605f, 605h, 605k, 605m1, 605m2, and/or 605m3) corresponding to the user interface element (e.g., 610, 624, 628, 632, 638, 640, 642) to perform the set of one or more actions and in accordance with a determination that a first set of one or more criteria is satisfied, the computer system displays (706), via the one or more display generation components, a prompt (and/or a user interface element and/or a notification) (e.g., a control and/or user interface element that is selectable and/or user interface element that contains a control) to confirm performance of the set of one or more actions (e.g., 616) (e.g., confirming that the one or more actions should be and/or are intended to be completed). In some embodiments, the first set of one or more criteria includes a criterion that is satisfied based on the one or more actions (e.g., a security level (e.g., ability for a device to control the accessibility to a private space (e.g., unlocking a door to a home and/or apartment, opening a garage door, and/or unlocking a gate to access a premises), thing (e.g., unlocking a safe, unlocking a device, and/or performing an action of a secure device), and/or information (e.g., gaining access to a network, gaining access to a secure device, and/or unlocking a secure space and/or location)), reversibility (e.g., the computer system and/or accessory device's ability to reverse one or more of the actions (e.g., preheating an oven, relocking a door, turning a light on and/or off, closing a garage door, and/or opening and/or closing blinds and/or windows)), and/or type of action (e.g., action completable by the computer system, completable via an accessory device, interacting with a network, and/or interacting with a physical device and/or appliance)), the input (e.g., repeated, accidental, long press, press and hold, swipe, and/or tap input) and/or the computer system (e.g., location, power state, level of activity (e.g., current actions running and/or pending), and/or connectivity to one or more accessory devices). In some embodiments, the computer system displays the prompt over, on top over, obstructing, and/or alongside the user interface to perform the set of one or more actions.

In response to (704) detecting the input corresponding to the user interface element to perform the set of one or more actions and in accordance with a determination that the first set of one or more criteria is not satisfied (and/or that the set of one or more actions is being and/or has been confirmed), the computer system displays (708), via the one or more display generation components, an indication (e.g., a user interface element, a notification, and/or another prompt different from the prompt) corresponding to (e.g., representing, confirming, and/or signaling) performance of the set of one or more actions without displaying the prompt (e.g., 628c, 642, and/or 610a). In some embodiments, the computer system displays the indication while and/or after performing (and/or causing performance of) the set of one or more actions (and/or receiving from the one or more accessory devices that the set of one or more actions is complete). In some embodiments, the indication represents the set of one or more actions (e.g., an active light, a speaker playing music, and/or another state of an accessory device). In some embodiments, the indication indicates that the set of one or more actions is being performed. In some embodiments, the indication indicates that the set of one or more actions has been successfully performed. In some embodiments, the indication indicates that the set of one or more actions has failed to be performed (e.g., at least one action of the set of one or more actions has failed to be performed). Selectively displaying a prompt to confirm performance of a set of one or more actions allows the computer system to (1) automatically provide a confirmation to perform the set of one or more actions based on the one or more actions and/or (2) automatically indicate the performance of the set of one or more actions without requiring user input, thereby performing an operation when a set of conditions has been met without requiring additional input.

In some embodiments, in response to detecting the input corresponding to the user interface element (e.g., 610, 624, 628, 632, 638, 640, 642) to perform the set of one or more actions (and/or in conjunction with (e.g., before, while, and/or after) displaying the indication corresponding to performance of the set of one or more actions) and in accordance with the determination that the first set of one or more criteria is not satisfied, the computer system causes (and/or requests) performance of the set of one or more actions (e.g., as described above at FIG. 6G) (e.g., via the computer system and/or one or more accessory devices such as a smart speaker, communal device, smart tv, audio visual equipment such as an audio visual receiver, speakers, and/or TV, network control device such as a hub device, modem, router, and/or network access points, outlet, camera, home condition system such as an air conditioner, thermostat, and/or heater, another computer system, head-mounted display, a network connected device such as alight, appliance, lock, garage door, and/or a device to control a physical object such as blinds, pet accessories, and/or windows in communication with the computer system). In some embodiments, the computer system causes performance of the set of one or more actions after the computer system ceases display of the prompt (e.g., in accordance with the determination that the first set of one or more criteria is satisfied and the computer system detects an input directed to the prompt. In some embodiments, the input directed to the prompt confirms the performance of the set of one or more actions). In some embodiments, the computer system is in communication with the one or more accessory devices. In some embodiments, the computer system requests that the one or more accessory devices perform the set of one or more actions (e.g., each accessory device of the one or more accessory devices is sent a request to perform a set of one or more actions corresponding to the accessory device) (e.g., different accessory devices of the set of one or more accessory devices are sent a different request when the different accessory devices are performing a different action of the set of one or more actions). In some embodiments, causing performance of the set of one or more actions includes requesting one or more accessory devices to perform the set of one or more actions. In some embodiments, causing performance of the set of one or more actions includes sending a message, playing music, reading the news, and/or other actions performable via the computer system. In some embodiments, the set of one or more actions includes actions performable by an accessory device (e.g., turning on and off remotely connected lights and/or devices such as speakers, TVs, and/or network devices). In some embodiments, the set of one or more actions include changing the state of an accessory device (e.g., increasing volume of a speaker, opening blinds, starting a coffee maker, and/or playing music). In some embodiments, causing performance of the set of one or more actions includes actions performable through interaction with a network (e.g., enabling an access point, connecting to another device, and/or managing a network). In some embodiments, causing performance of the set of one or more actions includes actions performable through interacting with a physical device and/or appliance (e.g., preheating an oven, starting a coffee maker, turning on an electric kettle, and/or opening blinds). Selectively causing performance of a set of one or more actions without displaying a confirmation to perform the set of one or more actions allows the computer system to determine whether the confirmation is necessary based on criteria rather than additional user input, thereby performing an operation when a set of conditions has been met without requiring additional input.

In some embodiments, after (and/or in response to) causing performance of the set of one or more actions (and/or after displaying the indication in accordance with the determination that the first set of one or more criteria is not satisfied) (and/or after displaying the prompt in accordance with the determination that the first set of one or more criteria is satisfied) (and/or in response to detecting the input corresponding to the user interface element to perform the set of one or more actions) and in accordance with a determination that a second set of one or more criteria is satisfied, the computer system displays, via the one or more display generation components, a control (e.g. 624, 628, and/o 632) (e.g., a user interface element, a selectable user interface element, and/or a user interface element configured to cause and/or request an action) to reverse (and/or undo) the set of one or more actions. In some embodiments, the second set of one or more criteria includes a criterion that is satisfied when one or more of the actions within the set of one or more actions is reversible (e.g., turning on and off lights, locking and unlocking locks, and/or activating and/or deactivating a connected device), when one or more of the actions within the set of one or more actions interact with a physical object and/or appliance (e.g., opening blinds, preheating an oven, and/or opening a garage door), and/or when one or more actions within the set of one or more actions interact with a private place, thing, or act (e.g., unlocking a door, sharing a network password, and/or unlocking a lockbox). In some embodiments, after (and/or in response to) causing performance of the set of one or more actions (and/or after displaying the indication in accordance with the determination that the first set of one or more criteria is not satisfied) (and/or after displaying the prompt in accordance with the determination that the first set of one or more criteria is satisfied) (and/or in response to detecting the input corresponding to the user interface element to perform the set of one or more actions) and in accordance with a determination that the second set of one or more criteria is not satisfied, the computer system forgoes display of the control (e.g., a user interface element, a selectable user interface element, and/or a user interface element configured to cause and/or request an action) to reverse (and/or undo) the set of one or more actions. In some embodiments, while (and/or after) displaying the control to reverse the set of one or more actions, the computer system detects, via the one or more input devices (e.g., 612), an input (e.g., a selection input and/or a non-selection input) corresponding to the control (e.g., 605k, 605f, and/or 605h). In some embodiments, the input corresponding to the control is a tap input on the control. In some embodiments, in response to detecting the input corresponding to the control, the computer system reverses the set of one or more actions (e.g., as described above at FIG. 6G). In some embodiments, the computer system reverses the one or more actions by performing the actions in an order previously performed, in an opposite order as previously performed, and/or in a predefined order (e.g., an order sorting by longest to reverse, quickest to reverse, and/or based on assigned location and/or priority). In some embodiments, the set of one or more actions is reversible when the set of one or more actions corresponds to one or more accessory devices that can receive an opposite instruction (e.g., turn on/off lights, lock/unlock a door, and/or turn on/off a TV). In some embodiments, the set of one or more actions is not reversible when one or more actions of the set of one or more actions is not reversible. In some embodiments, the set of one or more actions is not reversible if any, all of, and/or a majority of the set of one or more actions is not reversible. Displaying a control to reverse a set of one or more actions based on criteria allows the computer system (1) to automatically display the control without requiring additional user input and/or (2) provide the control only when relevant without cluttering a user interface, thereby performing an operation when a set of conditions has been met without requiring additional input and/or providing additional control options without cluttering the user interface with additional displayed controls.

In some embodiments, while displaying the prompt to confirm performance of the set of one or more actions (e.g., 628c, 642, and/or 610a), the computer system detects, via the one or more input devices (e.g., 612), an input (e.g., 605b, 605i, and/or 605n) (e.g., a selection input and/or a non-selection input) corresponding to the prompt (and/or a selectable portion and/or control of the prompt). In some embodiments, after detecting the input directed to the prompt, the computer system ceases display of the prompt. In some embodiments, the input corresponding to the prompt is tap input on the prompt. In some embodiments, in response to detecting the input corresponding to the prompt, the computer system causes (and/or requests) performance of the set of one or more actions (e.g., as described above at FIG. 6J) (via the computer system and/or one or more accessory devices). In some embodiments, the prompt includes a first control to confirm performance of the set of one or more actions and a second control, different from the first control, to decline performance of the set of one or more actions. In some embodiments, in response to detecting an input directed to the first control to confirm performance of the set of one or more actions, the computer system causes performance of the set of one or more actions. In some embodiments, in response to detecting an input directed to the second control to decline performance of the set of one or more actions, the computer system forgoes cause of performance of the set of one or more actions. In some embodiments, the computer system causes performance of the set of one or more actions after the computer system ceases display of the prompt in accordance with the determination that the first set of one or more criteria is satisfied and in response to detecting an input corresponding to the prompt (e.g., confirming the performance of the set of one or more actions). In some embodiments, after a predetermined amount of time since displaying the prompt, the computer system automatically declines performance of the set of one or more actions. In some embodiments, the computer system declines performance of the set of one or more actions in response to detecting an input not directed to the prompt. In some embodiments, causing performance of the set of one or more actions includes sending a message, playing music, reading the news, and/or other actions performable via the computer system. In some embodiments, the set of one or more actions includes actions performable by an accessory device (e.g., turning on and off remotely connected lights and/or devices such as speakers, TVs, and/or network devices). In some embodiments, the set of one or more actions include changing the state of an accessory device (e.g., increasing volume of a speaker, opening blinds, starting a coffee maker, and/or playing music). In some embodiments, causing performance of the set of one or more actions includes actions performable through interaction with a network (e.g., enabling an access point, connecting to another device, and/or managing a network). In some embodiments, causing performance of the set of one or more actions includes actions performable through interacting with a physical device and/or appliance (e.g., preheating an oven, starting a coffee maker, turning on an electric kettle, and/or opening blinds). Causing performance of a set of one or more actions after confirmation allows the computer system to selectively require confirmation prior to causing performance of the set of one or more actions based on criteria, thereby performing an operation when a set of conditions has been met without requiring additional input.

In some embodiments, the computer system (e.g., 600) is in communication with an accessory device. In some embodiments, the set of one or more actions consists of a single action with (and/or at) (and/or completed and/or performed by) the accessory device (e.g., as described above at FIGS. 6J and/or 6l). In some embodiments, an accessory device includes a smart speaker, communal device, smart tv, audio visual equipment (e.g., audio visual receiver, speakers, and/or TV), network control device (e.g., hub device, modem, router, and/or network access points), outlet, camera, home condition system (e.g., air conditioner, thermostat, and/or heater), another computer system, head-mounted display (HMD), and/or network connected device such as a light, appliance, lock, garage door, and/or a device to control a physical object such as blinds, a pet accessory, and/or windows. In some embodiments, the single action with the accessory device is performed via the accessory device. In some embodiments, the computer system causes performance of the single action with the accessory device by requesting the accessory device perform the single action. In some embodiments, the set of one or more actions includes one or more actions with (and/or at) (and/or completed by) the accessory device. In some embodiments, the set of one or more actions consists of one or more actions with (and/or at) (and/or completed by) the accessory device. Displaying a confirmation to cause performance of a single action at a single accessory device allows the computer system to automatically display the confirmation based on criteria irrespective of the number of actions and/or number of accessory devices, thereby performing an operation when a set of conditions has been met without requiring additional input.

In some embodiments, the computer system (e.g., 600) is in communication with a first accessory device and a second accessory device different from the first accessory device (e.g., as described above at FIG. 6A). In some embodiments, an accessory device includes a smart speaker, communal device, smart tv, audio visual equipment (e.g., audio visual receiver, speakers, and/or TV), network control device (e.g., hub device, modem, router, and/or network access points), outlet, camera, home condition system (e.g., air conditioner, thermostat, and/or heater), another computer system, head-mounted display (HMD), and/or network connected device (e.g., light, appliance, lock, garage door, and/or device to control a physical object such as blinds, a pet accessory, and/or windows). In some embodiments, the set of one or more actions includes an action that is performed by the first accessory device. In some embodiments, the action that is performed by the first accessory device is an action only performable by a type of accessory device and/or a particular accessory device (e.g., device assigned to complete the action and/or only device capable of performing the action). In some embodiments, the computer system causes performance of the action that is performed by the first accessory device by requesting the first accessory device perform the action. In some embodiments, the set of one or more actions includes an action that is performed by the second accessory device (e.g., as described above at FIG. 6A). In some embodiments, the action that is performed by the second accessory device is different and/or separate from the action that is performed by the first accessory device. In some embodiments, the action that is performed by the second accessory device is the same action as the action that is performed by the first accessory device. In some embodiments, an action that is performed by one of the respective accessory devices is an action only performable by a type of accessory device and/or particular accessory device (e.g., device assigned to complete the action and/or only device capable of performing the action). In some embodiments, an action at the accessory device includes performing the action via the accessory device. In some embodiments, the computer system causes performance of an action at the accessory device by requesting the accessory device perform the action. Including actions to be performed by different accessory devices within a set of one or more actions allows the computer system to determine whether to provide a prompt to confirm performance of the set of one or more actions based on different accessory devices without requiring user configuration, thereby performing an operation when a set of conditions has been met without requiring additional input.

In some embodiments, the computer system (e.g., 600) is in communication with a first accessory device and a second accessory device different from the first accessory device. In some embodiments, the first accessory device and/or the second accessory device includes a smart speaker, communal device, smart tv, audio visual equipment (e.g., audio visual receiver, speakers, and/or TV), network control device (e.g., hub device, modem, router, and/or network access points), outlet, camera, home condition system (e.g., air conditioner, thermostat, and/or heater), another computer system, head-mounted display (HMD), and/or network connected device (e.g., light, appliance, lock, garage door, and/or device to control a physical object such as blinds, a pet accessory, and/or windows). In some embodiments, varying types of accessory device includes accessory devices of different functions (e.g., lights, locks, and/or blinds), different assignments (e.g., subgroups of devices), and/or locations of devices (e.g., garage door, bedroom door, and/or front door) (e.g., living room lights, kitchen lights, and/or bedroom lights). In some embodiments, the first accessory device is a first type of accessory device and the second accessory device is a second type of accessory device different from the first type of accessory device (e.g., as described above at FIG. 6A). In some embodiments, the first type of accessory device and/or the second type of accessory device includes a type of action (e.g., action performable on a particular type of accessory device), assignment (e.g., action assigned to be completed by a particular accessory device), and/or location (e.g., action completed in a particular area). In some embodiments, the first set of one or more criteria includes a criterion that is satisfied when a set of one or more accessory devices (and/or that are in communication with the computer system) includes accessory devices of different types (e.g., one or more accessory devices of a first type and one or more accessory devices of a second type different from the first type). In some embodiments, the set of one or more actions includes a first action that is performed by the first accessory device (e.g., as described above at FIG. 6C). In some embodiments, the first action is only performable on the first type of accessory device (e.g., the first action is compatible with the first type of accessory device and/or the first action can only be completed by the first type of accessory device). In some embodiments, the first action is assigned to the first accessory device (e.g., the computer system automatically assigns the first action to the first accessory device and/or a user preference assigning the first action to the first accessory device). In some embodiments, the set of one or more actions includes a second action that is performed by the second accessory device (e.g., as described above at FIG. 6C). In some embodiments, the second action is only performable on the second type of accessory device (e.g., the second action is compatible with the second type of accessory device and/or the second action can only be completed by the second type of accessory device). In some embodiments, the second action is assigned to the second accessory device (e.g., the computer system automatically assigns the second action to the first accessory device and/or a user preference assigning the second action to the second accessory device). In some embodiments, the second action and the first action are different types of action, different instances of an action, and/or an action assigned to different accessory devices. Including actions to be performed by different types of accessory devices within a set of one or more actions allows the computer system to determine whether to provide a prompt to confirm performance of the set of one or more actions based on the different types of the accessory devices without requiring user configuration, thereby performing an operation when a set of conditions has been met without requiring additional input.

In some embodiments, the first set of one or more criteria includes a criterion that is satisfied when the set of one or more actions is determined not to be reversible. In some embodiments, reversibility is based on an ability of the computer system and/or an accessory device to reverse an action of the set of one or more actions (e.g., preheating an oven, relocking a door, turning a light on and/or off, closing a garage door, and/or opening and/or closing blinds and/or windows). Selectively displaying a prompt to confirm performance of a set of one or more actions based on the reversibility of the actions allows the computer system to automatically display the prompt when a certain type of action is to be performed, thereby performing an operation when a set of conditions has been met without requiring additional input.

In some embodiments, the computer system (e.g., 600) is in communication with a first accessory device (e.g., smart speaker, communal device, smart tv, audio visual equipment (e.g., audio visual receiver, speakers, and/or TV), network control device (e.g., hub device, modem, router, and/or network access points), outlet, camera, home condition system (e.g., air conditioner, thermostat, and/or heater), another computer system, head-mounted display (HMD), and/or network connected device (e.g., light, appliance, lock, garage door, and/or device to control a physical object (e.g., blinds, pet accessory, and/or windows))). In some embodiments, an action of the set of one or more actions corresponds to (and/or that is performed by) the first accessory device. In some embodiments, the first set of one or more criteria includes a criterion that is satisfied when a security level (and/or level of access and/or privacy) corresponding to the (e.g., associated with, of, and/or assigned to) accessory device is greater than a predefined required security level (e.g., as described above at FIG. 6N). In some embodiments, the security level corresponding to the accessory device corresponds to the ability of a device to control the accessibility to a private space (e.g., unlocking a door to a home and/or apartment, opening a garage door, and/or unlocking a gate to access a premises), an object (e.g., unlocking a safe, unlocking a device, and/or performing an action of a secure device), and/or information (e.g., gaining access to a network, gaining access to a secure device, and/or unlocking a secure space and/or location). In some embodiments, the predefined required security level is a threshold value and/or score (e.g., level of security associated with an action and/or accessory device) (e.g., level of security associated with completing a certain action by the accessory device such as unlocking a front door requiring a higher level of security than turning on a room light). Selectively displaying a prompt to confirm performance of a set of one or more actions based on a security determination allows the computer system to automatically display the prompt when a certain type of action requiring a certain security level to be performed, thereby performing an operation when a set of conditions has been met without requiring additional input.

In some embodiments, the user interface element (e.g., 610, 624, 628, 632, 638, 640, 642) to perform the set of one or more actions is displayed within (and/or is) a watch complication (e.g., 638 and/or 640). In some embodiments, a watch complication is additional functionality and/or features within a watch outside of outside of telling the time (e.g., in a traditional analog watch, a watch complication can consist of date, month, additional time zone time, and/or moon phases) (e.g., in a traditional digital watch, a watch complication can consist of stopwatch functionality, timer functionality, and/or alternate watch faces or fonts) (e.g., in a smart watch, a watch complication can consist of functionality provided by one or more applications, one or more system and/or hardware functionalities, and/or one or more additional computer systems). In some embodiments, a watch complication is a fixed (e.g., maintained in a position and/or portion of a user interface while other user interfaces are removed, repositioned, and/or added to the user interface) user interface element displayed in a portion of a user interface displayed by the one or more display generation components irrespective of additional user interface elements in the user interface. In some embodiments, the watch complication is defined by a user (e.g., assigning accessory devices to a user interface element, assigning a user interface element to a fixed location on the user interface displayed by the one or more display generation components, and/or enabling the display of the watch complication on a particular portion of the user interface displayed by the one or more display generation components). In some embodiments, a watch complication includes system information (e.g., time, battery level, connectivity, and/or activity of a hardware component (e.g., active microphone and/or speaker)), environment information (e.g., time, weather, location, proximity to an accessory device, and/or activity of an accessory device), user information (e.g., user activity information (e.g., miles walked, stairs climbed, and/or time spent standing), health information (e.g., current heart rate, electrocardiogram information, and/or pulse oxygen information)), content from one or more applications (e.g., information and/or controls from an application on the computer system and/or another computer system), and/or information from another computer system (e.g., notification from another computer system, battery level of another computer system, and/or connectivity to another computer system). In some embodiments, the computer system displays a watch complication in a position based on the user interface the watch complication is within (e.g., watch complication is required to be in a particular location based on the watch complications size, content, and/or activity). In some embodiments, a color scheme of the computer system and/or another user interface impacts the watch complication (e.g., altering the color scheme of the watch complication to be consistent with other user interfaces and/or user interface elements). Displaying a user interface element to cause performance of a set of one or more actions within a watch complication allows the computer system to display the user interface element in a manner allowing for control of the set of one or more actions without displaying additional clutter in a user interface of a watch, thereby providing additional control options without cluttering the user interface with additional displayed controls.

In some embodiments, the user interface element (e.g., 610, 624, 628, 632, 638, 640, and/or 642) is displayed in a first user interface (e.g., 602). In some embodiments, the prompt (e.g., 616) to confirm performance of the set of one or more actions is displayed in a second user interface (e.g., 614) different from the first user interface. In some embodiments, the computer system ceases to display the first user interface as a part of displaying the second user interface. In some embodiments, the second user interface is displayed as overlaid over the first user interface. In some embodiments, the computer system displays the first user interface as a part of ceasing to display the second user interface. In some embodiments, the computer system displays the second user interface on top of the first user interface that includes watch complications. In some embodiments, the computer system displays the second user interface on top of the first user interface that does not include watch complications. Displaying a prompt to confirm performance of a set of one or more actions in different user interface than a user interface element to cause performance of the set of one or more actions allows the computer system enable access to additional functionality within a watch based user interface without cluttering the user interface, thereby providing additional control options without cluttering the user interface with additional displayed controls.

In some embodiments, before detecting the input (e.g., 605a, 605f, 605h, 605k, 605m1, 605m2, and/or 605m3) corresponding to the user interface element (e.g., 610, 624, 628, 632, 638, 640, and/or 642), the computer system displays (e.g., automatically displays), via the one or more display generation components, the user interface element to perform the set of one or more actions without detecting an input via the one or more input devices (e.g., 612). In some embodiments, the user interface element is displayed in response to a determination that the computer system is in a particular state (e.g., connectivity, battery level, and/or state such as a do not disturb mode and/or focused mode), one or more accessory devices is in a particular state (e.g., connectivity, power state, current activity level, and/or previous status), a current context is in a particular state (e.g., current and/or future weather, time, and/or activity and/or event associated with the computer system and/or a user of the computer system such as the user having an upcoming meeting, house party, and/or vacation), the computer system is at a particular location (e.g., the computer system is within a portion of a home, the computer system is moving towards a garage door, and/or an accessory device is performing an action within a location with other accessory devices), and/or a user preference is set to a particular state (e.g., the user has a preference of turning on lights in the morning, turning off lights after a certain amount of time, locking all doors before bed, and/or playing a playlist in the morning). In some embodiments, the computer system ceases display of the user interface element to perform the set of one or more actions in response to a determination that one or more of the determinations described above are not satisfied. Selectively displaying a user interface element to cause performance of a set of one or more actions allows the computer system to display the user interface element without requiring user input, thereby performing an operation when a set of conditions has been met without requiring additional input.

In some embodiments, before displaying the user interface element (e.g., 610, 624, 628, 632, 638, 640, 642) to perform the set of one or more actions, the computer system detects, via the one or more input devices, an input (e.g., a selection input and/or a non-selection input) corresponding to (e.g., directed to, at a location of, related to and/or associated with) a request to add the user interface element to a respective position in a user interface. In some embodiments, in response to (and/or after) detecting the input corresponding to the request to add the user interface element to the respective position in the user interface, the computer system displays, via the one or more display generation components, the user interface element at the respective position in the user interface (e.g., as described above at FIG. 6M). In some embodiments, displaying the user interface element in the respective position in the user interface includes pinning and/or fixing (e.g., consistently displaying irrespective of other displayed user interface elements) the user interface element to the respective position in the user interface, displaying the user interface element in a folder of one or more additional user interface elements, and/or displaying the user interface element as a control. In some embodiments, the user interface element is fixed and/or pinned in the respective position of the user interface (e.g., defined by default, user preference, and/or context). In some embodiments, when the position of the user interface is defined by a context the context includes relevance such as the proximity of the computer system to an accessory device, certain time of day and/or previous use at location, time, and/or activity. In some embodiments, the user interface element is dynamic within the user interface (e.g., displayed within different portions of the user interface based on context). In some embodiments, while the user interface is included in a group of user interface elements and the user interface element is pinned and/or fixed, the user interface element remains at the respective position of the user interface as the other user interface elements within the group are moved, repositioned, removed, and/or displayed. Configuring where a user interface element is to be displayed within a user interface allows the computer system to display the user interface element differently based on configuration by a user, thereby providing additional control options without cluttering the user interface with additional displayed controls.

In some embodiments, displaying the user interface element (e.g., 610, 624, 628, 632, 638, 640, 642) at the respective position in the user interface (e.g., 634) includes, in accordance with a determination that the respective position is a first position, displaying, via the one or more display generation components, the user interface element at the first position within the user interface and in accordance with a determination that the respective position is a second position different from the first position, displaying, via the one or more display generation components, the user interface element at the second position within the user interface (e.g., as described above at FIG. 6M). Configuring a user interface element to be displayed at different positions within a user interface allows a user more control of their configurations and how the user interface will appear, thereby performing an operation when a set of conditions has been met without requiring additional input. In some embodiments, the first position is a default and/or initial position (e.g., user preferred location and/or default location based on one or more characteristics of the user interface element such as type, size, and/or actions associated with the user interface element).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the display of controls. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for the targeted display of controls. Accordingly, use of such personal information data enables users to have a computer system perform operations for displaying controls. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is communication with one or more input devices and one or more display generation components:
while displaying, via the one or more display generation components, a user interface element to perform a set of one or more actions, detecting, via the one or more input devices, an input corresponding to the user interface element; and
in response to detecting the input corresponding to the user interface element to perform the set of one or more actions:
in accordance with a determination that a first set of one or more criteria is satisfied, displaying, via the one or more display generation components, a prompt to confirm performance of the set of one or more actions; and
in accordance with a determination that the first set of one or more criteria is not satisfied, displaying, via the one or more display generation components, an indication corresponding to performance of the set of one or more actions without displaying the prompt.

2. The method of claim 1, further comprising:
in response to detecting the input corresponding to the user interface element to perform the set of one or more actions and in accordance with the determination that the first set of one or more criteria is not satisfied, causing performance of the set of one or more actions.

3. The method of claim 2, further comprising:
after causing performance of the set of one or more actions and in accordance with a determination that a second set of one or more criteria is satisfied, displaying, via the one or more display generation components, a control to reverse the set of one or more actions;
while displaying the control to reverse the set of one or more actions, detecting, via the one or more input devices, an input corresponding to the control; and
in response to detecting the input corresponding to the control, reversing the set of one or more actions.

4. The method of claim 1, further comprising:
while displaying the prompt to confirm performance of the set of one or more actions, detecting, via the one or more input devices, an input corresponding to the prompt; and
in response to detecting the input corresponding to the prompt, causing performance of the set of one or more actions.

5. The method of claim 1, wherein the computer system is in communication with an accessory device, and wherein the set of one or more actions consists of a single action with the accessory device.

6. The method of claim 1, wherein:
the computer system is in communication with a first accessory device and a second accessory device different from the first accessory device;
the set of one or more actions includes an action that is performed by the first accessory device; and
the set of one or more actions includes an action that is performed by the second accessory device.

7. The method of claim 1, wherein:
the computer system is in communication with a first accessory device and a second accessory device different from the first accessory device;
the first accessory device is a first type of accessory device and the second accessory device is a second type of accessory device different from the first type of accessory device;
the set of one or more actions includes a first action that is performed by the first accessory device; and
the set of one or more actions includes a second action that is performed by the second accessory device.

8. The method of claim 1, wherein the first set of one or more criteria includes a criterion that is satisfied when the set of one or more actions is determined not to be reversible.

9. The method of claim 1, wherein the computer system is in communication with a first accessory device, wherein an action of the set of one or more actions corresponds to the first accessory device, and wherein the first set of one or more criteria includes a criterion that is satisfied when a security level corresponding to the accessory device is greater than a predefined required security level.

10. The method of claim 1, wherein the user interface element to perform the set of one or more actions is displayed within a watch complication.

11. The method of claim 1, wherein the user interface element is displayed in a first user interface, and wherein the prompt to confirm performance of the set of one or more actions is displayed in a second user interface different from the first user interface.

12. The method of claim 1, further comprising:
before detecting the input corresponding to the user interface element, displaying, via the one or more display generation components, the user interface element to perform the set of one or more actions without detecting an input via the one or more input devices.

13. The method of claim 1, further comprising:
before displaying the user interface element to perform the set of one or more actions, detecting, via the one or more input devices, an input corresponding to a request to add the user interface element to a respective position in a user interface; and
in response to detecting the input corresponding to the request to add the user interface element to the respective position in the user interface, displaying, via the one or more display generation components, the user interface element at the respective position in the user interface.

14. The method of claim 13, wherein displaying the user interface element at the respective position in the user interface includes:
in accordance with a determination that the respective position is a first position, displaying, via the one or more display generation components, the user interface element at the first position within the user interface; and
in accordance with a determination that the respective position is a second position different from the first position, displaying, via the one or more display generation components, the user interface element at the second position within the user interface.

15. A non-transitory computer-readable storage medium storing one or more programs configured to be executed by one or more processors of a computer system that is communication with one or more input devices and one or more display generation components, the one or more programs including instructions for:
while displaying, via the one or more display generation components, a user interface element to perform a set of one or more actions, detecting, via the one or more input devices, an input corresponding to the user interface element; and
in response to detecting the input corresponding to the user interface element to perform the set of one or more actions:
in accordance with a determination that a first set of one or more criteria is satisfied, displaying, via the one or more display generation components, a prompt to confirm performance of the set of one or more actions; and
in accordance with a determination that the first set of one or more criteria is not satisfied, displaying, via the one or more display generation components, an indication corresponding to performance of the set of one or more actions without displaying the prompt.

16. A computer system that is communication with one or more input devices and one or more display generation components, comprising:
one or more processors; and
memory storing one or more programs configured to be executed by the one or more processors, the one or more programs including instructions for:
while displaying, via the one or more display generation components, a user interface element to perform a set of one or more actions, detecting, via the one or more input devices, an input corresponding to the user interface element; and
in response to detecting the input corresponding to the user interface element to perform the set of one or more actions:
in accordance with a determination that a first set of one or more criteria is satisfied, displaying, via the one or more display generation components, a prompt to confirm performance of the set of one or more actions; and
in accordance with a determination that the first set of one or more criteria is not satisfied, displaying, via the one or more display generation components, an indication corresponding to performance of the set of one or more actions without displaying the prompt.
